(19) United States
(12) Patent Application Publication
(10) Pub. No.: US 2016/0137466 A1
(43) Pub. Date: May 19, 2016

(54) System for Hoisting a Load on an Offshore Rig

(71) Applicant: NATIONAL OILWELL VARCO NORWAY AS, Kristiansand S (NO)

(72) Inventors: Hans Anders ERIKSSON, LILLESAND (NO); Yngvar BORØY, SØGNE (NO); Oddbjøm ØYE, Kristiansand S (NO); Geir Odd BERGSTØL, Kristiansand (NO); Stig TRYDAL, Søgne (NO)

(21) Appl. No.: 14/900,733

(22) PCT Filed: Jun. 25, 2014
(86) PCT No.: PCT/NO2014/050113

§ 371 Date: Dec. 22, 2015

Related U.S. Application Data
(60) Provisional application No. 61/839,194, filed on Jun. 25, 2013.

(51) Int. Cl. B66D 1/82; E21B 19/084; B66D 1/14; E21B 19/00; B66D 1/12; E21B 41/00; E21B 19/02

(52) U.S. Cl. CPC B66D 1/82; E21B 41/00; E21B 19/084; E21B 19/02; E21B 19/006; B66D 1/12; B66D 1/14

(57) ABSTRACT

There is described a system for hoisting a load on an offshore rig, the system comprising
a winch having a winch drum;
drive means for operating said winch;
one or more sheaves;
an elongated hoisting member, such as a wire rope, configured to run over said one or more sheaves and to connect said winch to a load, wherein said winch drum, in a first position of use (A), is configured to accommodate only a single layer of said elongated hoisting member.

### CROSS-REFERENCE TO RELATED APPLICATIONS

This Preliminary Amendment is filed concurrently with the National Phase Entry patent application that claims priority to PCT/NO2014/050113 having the international filing date of Jun. 25, 2014 and U.S. Provisional Application No. 61/839,194 filed Jun. 25, 2013. Prior to calculating the fees and initial examination of the above-styled case, the Examiner is requested to enter the following amendments.

### STATEMENT REGARDING FEDERALLY SPONSORED RESEARCH OR DEVELOPMENT

Not applicable.

### BACKGROUND

This disclosure relates to a system for hoisting a load on an offshore rig. configured

Hoisting of heavy loads on drilling rigs has traditionally been done by means of a winch accommodating multiple layers of wire rope. The wire rope is connected to a load through a draw-works including many small sheaves over which the wire runs and is repeatedly bent. During lifting and lowering, and particularly in heave compensation, the wire rope undergoes numerous bending cycles under load, and is therefore subject to considerable wear. Depending on the number of sheaves in the draw-works, i.e. the mechanical advantage, the wire rope on the winch side, the so-called fast line, travels a longer distance than the load, thus requiring multiple layers of wire rope on the winch. Overlying layers of wire rope act with great forces on underlying layers on the winch drum, thus further increasing the wear of the wire rope. Inertia loss in the great number of sheaves in the draw-works also leads to a rather slow acceleration of the load, thus slowing down the operation time. The typical lifetime of a wire rope used together with a multi-layer winch in heave compensation mode on a drilling rig is in the order of two weeks, leading to frequent stops of operation to perform a traditional cut-and-slip to replenish the wire rope.

Prior art hoisting systems on offshore rigs typically use only one wire connected to a winch in one end, running to the top of a derrick through a crown block and down to a travelling block, to which the load is connected, and further to a deadline anchor, typically anchored to the rig floor or to the derrick. When using only one wire, it is of the utmost importance that the wire does not break, as this could cause severe damage to rig and harm to personnel. The fear of wire fatigue also contributes to the frequent replenishment of wire rope. Wires used for heavy lifting operations are very expensive.

### SUMMARY

A Disclosed are systems and apparatus aimed at increasing the lifetime of wire ropes used in offshore hoisting operations, and in particular wire ropes used for lifting drill pipes and stands in active heave compensation and for lifting complete drill strings. The systems and apparatus are also aimed at improving safety in offshore lifting operations as well as reducing operation times.

Disclosed is a system for hoisting a load on an offshore rig, the system comprising
a winch having a winch drum;
drive means for operating said winch;
one or more sheaves,
an elongated hoisting member, such as a wire, configured to run over said one or more sheaves and to connect said winch to a load, wherein said winch drum, in a first position of use, is configured to accommodate a single layer of said elongated hoisting member, such that the single layer is free from being contacted by a subsequent layer disposed on top of the single layer.

In the following the elongated hoisting member will be exemplified by a wire rope. The use of a single-layer winch offers several advantages over conventional multi-layer winches that have traditionally been used on offshore rigs. In a multi-layer winch, underlying layers of wire rope will typically be exposed to great wear and tear from overlying layers, hence reducing the lifetime of the wire. Multi-layer winches have been required when using traditional draw-works on drilling rigs, with relatively small winches and a great number of sheaves to achieve the necessary mechanical advantage. The wire rope undergoes numerous bending cycles around the sheaves. The fast line from the winch travels many times the distance of the load, connected to the travelling block. Hence, multiple layers of wire are required to accommodate a wire of sufficient length. A system hoisting a load on a drilling rig including a single layer winch preferably should include a limited number of sheaves between the load and the winch. In preferred embodiments, the sheaves in the crown block and travelling block may be arranged so as to give a transmission in the range of 2:1 to 4:1. In one embodiment, the winch may even be a so-called direct line winch with no transmission/gearing in the sheaves.

In one embodiment the system may comprise two or more parallel wires connecting said winch to said load. The use of multiple parallel wires may significantly improve safety, as the system may operate in redundancy with respect to the number of required wires. In case of wire failure, and even if a wire breaks, the system may still be operating within its capacity. The parallel wires may be connected to the same winch drum. The number of parallel wires is not limited, but in exemplary embodiments, the system may comprise two to six parallel wires.

In one embodiment said winch drum may be provided with a helical groove for accommodating said single layer of wire rope. The helical groove will prevent the wire on the winch from wear, as it prevents cross-contact between neighbouring wire layers, thus further increasing the lifetime of the wire rope. The winch drum may be provided with one groove for each wire rope, where several parallel wire ropes are used.

In one embodiment, the system may further comprise motion compensation means, such as heave compensation means. This may be preferable if the system is provided on an offshore drilling rig where there is a need to compensate for undesired movement of the load due to wind and waves. In one embodiment, the winch itself may be provided with heave compensation means. Traditionally, repeated lifting and lowering of a load, such as a drill string section during tripping, has entailed numerous wire rope bending cycles around the multiple sheaves in draw-works, leading to an extensive wear and reduced lifetime of the wire rope. Heave compensation by means of a system disclosed herein will not wear the wire rope to the same extent due to the fact that the wire rope only undergoes a few, if any, bending cycles during lifting and lowering. It is also preferable to use relatively large sheaves, implying that a large part of the wire stays on the sheave upon lifting and lowering, hence not leaving the sheave, and thus not undergoing a bending cycle.

In one embodiment, a ratio between the diameter of said winch drum in the first position of use and the diameter of said elongated hoisting member may be larger than 30, preferably larger than 40 and even more preferably in the range of 60 or larger. Said ratio is oftentimes called the D/d ratio, where D is the diameter of the winch drum and d the diameter of the wire rope. A high D/d ratio has been shown to be particularly important for offshore winch applications. Traditionally winches and wire ropes used for offshore drilling applications have had a D/d ratio of around 30. In one embodiment, an increased D/d ratio from 30 to 60 increases the lifetime of the wire rope approximately fivefold, thus contributing to increased wire rope lifetime. The use of a single-layer winch with a large winch drum significantly contributes to the increased D/d ratio. Preferably also, the sheaves in the system should have a large D/d ratio, with D now being the diameter of a sheave instead of the diameter of the winch drum. The sheave D/d ratio could also be in the range of 60 or larger. A person skilled in the art will understand that the diameter d of the wire rope will depend on the capacity of the system in which it is to be used, the number of parallel wire ropes, and the required safety factor. The safety factor of the wire rope should preferably be 3 or even larger. As an example, in a system with a safe working load of 1250 short tons, six parallel wire ropes with a diameter of 66 millimetres may run over two-parts blocks in the derrick. Sheaves and the winch drum may have a D/d ratio of 60 or even larger, thus requiring diameters in the range of four meters. Various embodiments of the disclosed hoisting system may be configured to lift from 200 to 750 short tons in well intervention applications, and even up to 2000 short tons in drilling operations.

In one embodiment, the winch drive means may be a plurality of electric drive means. By using a plurality of smaller drive means, instead of one large drive means, system safety and flexibility may be further improved. In case of failure in one of several electric drive means, the system may still be run within its safety limits, thus also reducing downtime.

Said electric drive means may be permanent magnet motors, such as permanent magnet AC synchronous motors. Such permanent magnet motors are known to be compact, reliable and cost-efficient, while at the same time requiring little maintenance.

Each of said plurality of permanent magnet motors may be connected to said winch via a separate gear. Each of said gears may further be connected to a separate gear shifting means configured to shift gears and to disconnect said permanent magnet motor from the winch. A mal-functioning non-disconnected permanent magnet motor will rotate with the winch drum, produce energy, and therefore constitute a potential safety hazard. It is therefore advantageous to be able to disconnect each of the permanent magnet motors, should it be required. In contrast to traditional draw-works, at least some gearing according to this embodiment is done directly at the winch. Load acceleration will also be significantly better compared to traditional draw-works, thus leading to a quicker response and less energy-consumption. The permanent magnet motors may therefore be run at a fixed, optimized speed, while wire speed is regulated through the winch gears. Said separate gear may be a two-step gear wherein in a first gear, the winch is configured to lift and/or lower a first load, and wherein in a second gear, the winch is configured to perform multiple lifting and lowering operations of a second load. The first gear and the first load may correspond to a mode where the system is used for lifting and/or lowering a drill string, where much power but not so much speed is required. The second gear and the second load may correspond to tripping with a drill stand, where less power but more speed is required. The gear shifting means may be configured to switch between the two gears and to disconnect the permanent magnet motor, to which the gear is connected, from said winch.

In one exemplary embodiment, the gear shifting means may be configured to shift gear under load. This may be done by running each motor, one or a few at the time, consecutively in a slight overspeed, and change gear while in overspeed, while the rest of the motors are under load. This may speed up processing time and the transmission between slow and fast speed. A person skilled in the art will understand that the motors and motor speed may be controlled by a winch control unit, which may be a PLC or the like.

In one embodiment, the elongated hoisting member may be a galvanized steel wire. Galvanized steel wires have not conventionally been used in heave compensation on offshore rigs. The fact that wires typically have been worn out in about two weeks did not justify, from a cost perspective, the use of galvanized wires. However, together with an offshore hoisting system accordingly to exemplary embodiments disclosed herein, where the lifetime of wires is significantly increased, the use of galvanized wires may further increase the lifetime of the wire, and thus further reduce costs over time.

In one embodiment, said elongated hoisting member may be a wire rope including more than six strands. This will result in a smoother surface of the wire rope and thus reduced risk of the wire rope getting tangled compared to wire ropes with fewer strands which have traditionally been used in these kinds of operations. Together with the fact that the wire is provided in a single-layer, and preferably in a helical groove, on the winch drum, this will further lead to reduced wear and thus increased lifetime of the wire rope.

In one embodiment, said winch may comprise a removable shell defining an outer layer of said winch drum, and wherein the winch with said shell defines said first position of use, and wherein said winch without said shell defines a second position of use wherein the winch is configured to accommodate multiple layers of said elongated hoisting member. In this second position of use, the winch may also, for instance, serve as a subsea hoisting winch, i.e. for lowering or lifting loads to or from a seabed. Such operations will require a much longer wire rope than for instance heave-compensated derrick operations. Still, subsea hoisting operations are not frequently performed, hence wear of the wire rope is not a big issue. This embodiment may save cost and space as one winch may be used for several purposes for which, traditionally, two or more winches have been required.

In one embodiment, said removable shell may include a plurality of shell segments configured to be assembled to define said removable shell. This may make it easier to assemble and dis-assemble the shell. In one embodiment, the shell may include three segments of substantially equal size, i.e. each covering a sector of substantially 120° around the winch drum core.

It has been found that by implying one or more of the various embodiments described above, the average lifetime of a wire used on an offshore drilling rig may be increased from two weeks, which is the current situation, up to as much as five years and even more.

There is also described an offshore drilling rig comprising a system according to any of the embodiments described above.

### BRIEF DESCRIPTION OF THE DRAWINGS

In the following description, the various embodiments are illustrated in the accompanying drawings, wherein:

FIG. 1 shows, in a perspective view, a winch as used in a system according the present disclosure;

FIG. 2 shows, in a side view, a system according to the present disclosure;

FIG. 3 shows, in a schematic view, a hoisting system according to prior art;

FIG. 4 shows, in a schematic view, a hoisting system according to the present disclosure;

FIG. 5 shows, in a perspective view, a winch made in accordance with this disclosure, the wince shown in a first position of use;

FIG. 6 shows the winch from FIG. 5 in a second position of use;

FIG. 7a shows a winch drum segment in two different views; and

FIG. 7b shows a winch drum support means in two different views.

### DETAILED DESCRIPTION OF DISCLOSED EXEMPLARY EMBODIMENTS

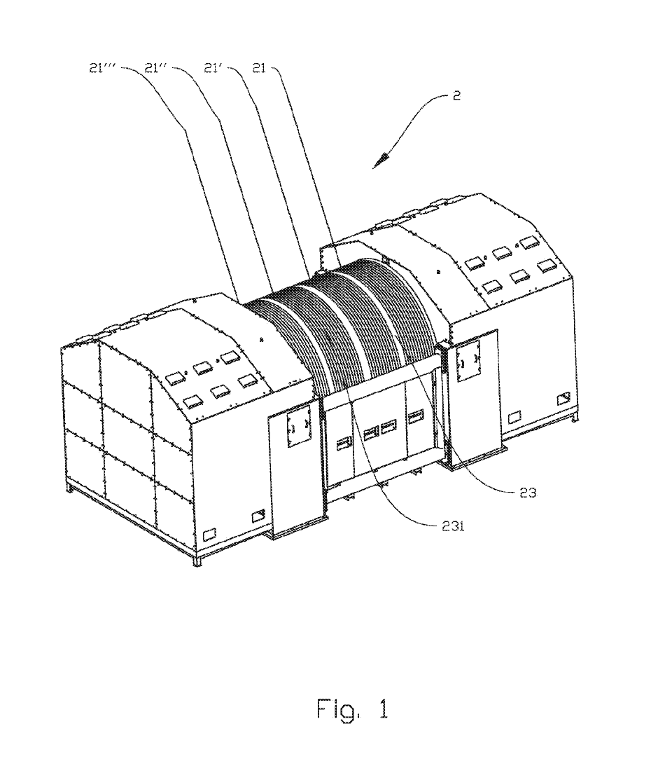

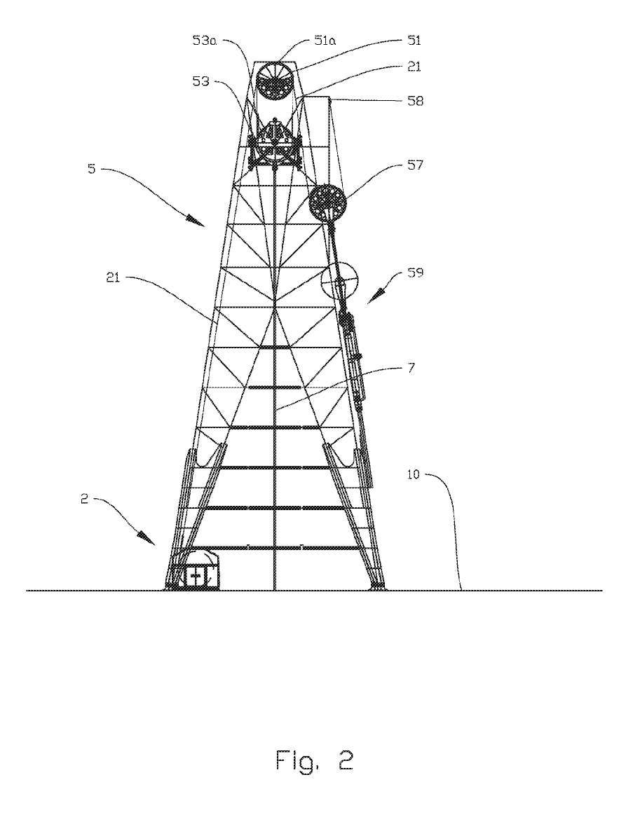

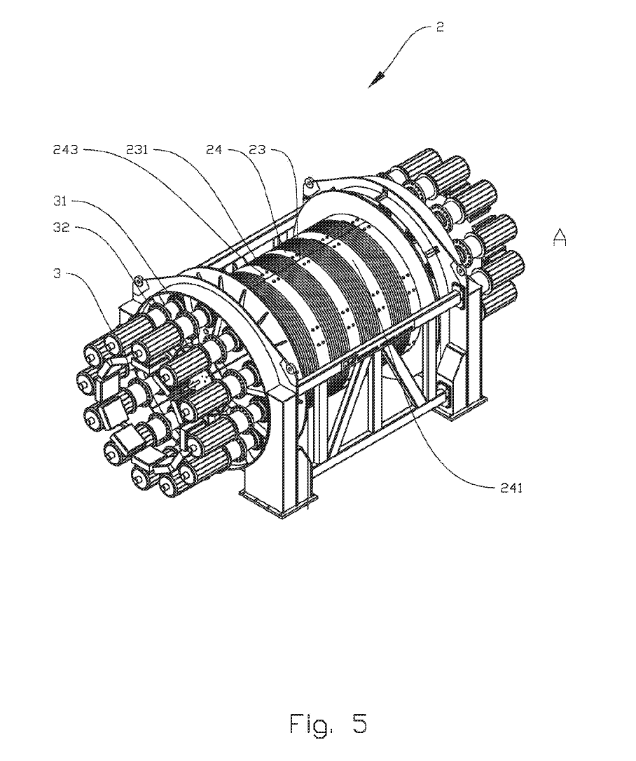

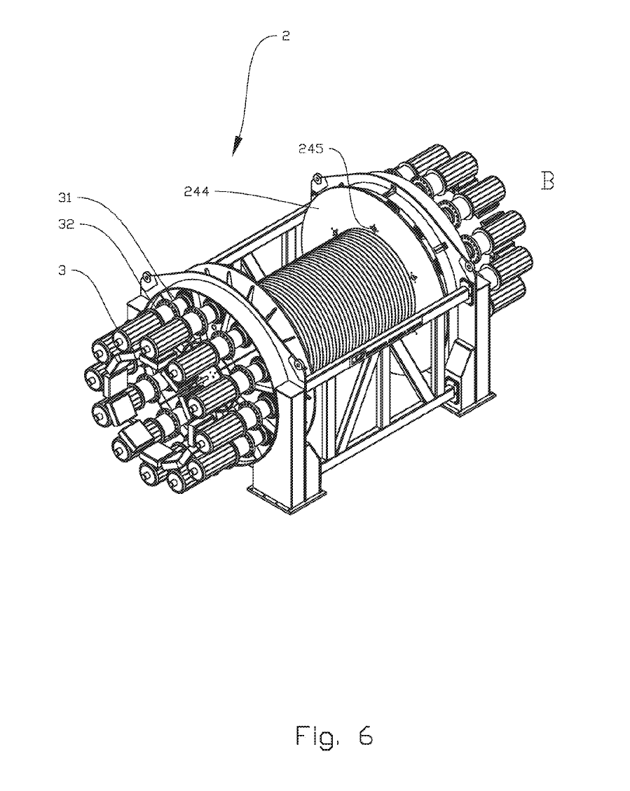

In the following description, identical reference numerals indicate identical or similar features on the figures, which are shown simplified and/or in schematic form. FIG. 1 shows a winch 2 suitable for use in a system shown in FIG. 2 and discussed below. The winch 2 comprises a winch drum 23 formed with helical grooves 231, into which four parallel elongated hoisting members 21, 21′, 21″, 21′ in the form of galvanized steel wire ropes with high quality polymer plastic inserts are wound around the winch drum 23 in a single layer. The wires 21, 21′, 21″, 21′ are connected to the winch drum 23 by means of (not shown) wire clamps. The helical grooves 231 prevent cross-over damage in each wire rope 21, 21′, 21″, 21′ and between adjacent wire ropes 21, 21′, 21″, 21″′. The winch 2 will be described more in detail with reference to FIGS. 5 and 6 below.

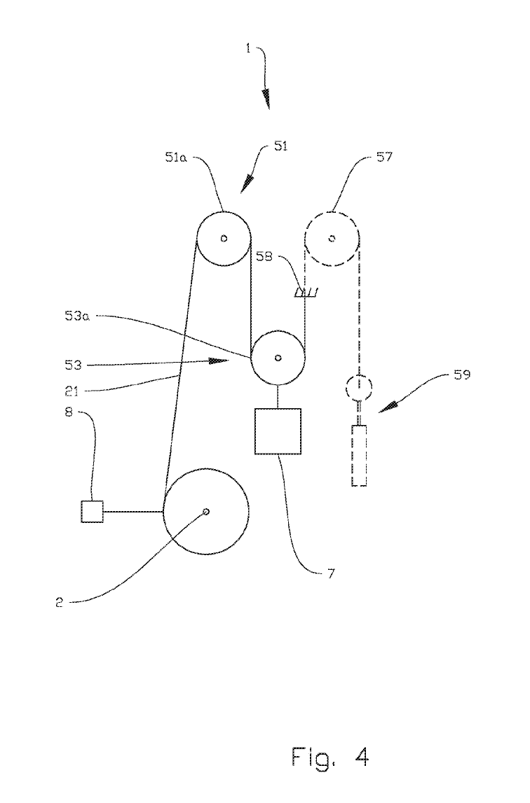

In FIG. 2, a system 1 is shown to include a derrick 5 that is positioned on a rig floor 10 of a (not shown) offshore drilling rig. The winch 2 is provided on the rig floor 10 and is provided with active heave compensation means 8, as shown schematically in FIG. 4. The heave compensation means 8 is configured to control the winch 2 so as to keep the height of a load 7, here shown as a drill string, constant relative to the seafloor. It will be understood that the four wire ropes 21, 21′, 21″, 21″′ run in parallel from the winch 2, but that only one wire rope 21 is visible in the shown side view. The wire rope 21 run over a crown block 51, with a sheave 51a, down around a travelling block 53, with sheave 53a, over the crown block 51 again at a second, not shown, sheave, down around a compensating sheave 57 and up to a deadline anchor 58. In the embodiment shown in FIG. 2, the compensating sheave 57 is connected to a deadline compensator 59. The functionality of the deadline compensator 59 will be well known to a person skilled in the art and is not discussed in any detail herein. The transmission in the system 1 shown in FIG. 2 is 2:1, in contrast to in the range of 16:1 in certain conventional draw-works. In an alternative embodiment, the winch 2 could even be a direct line winch, i.e. without any transmission.

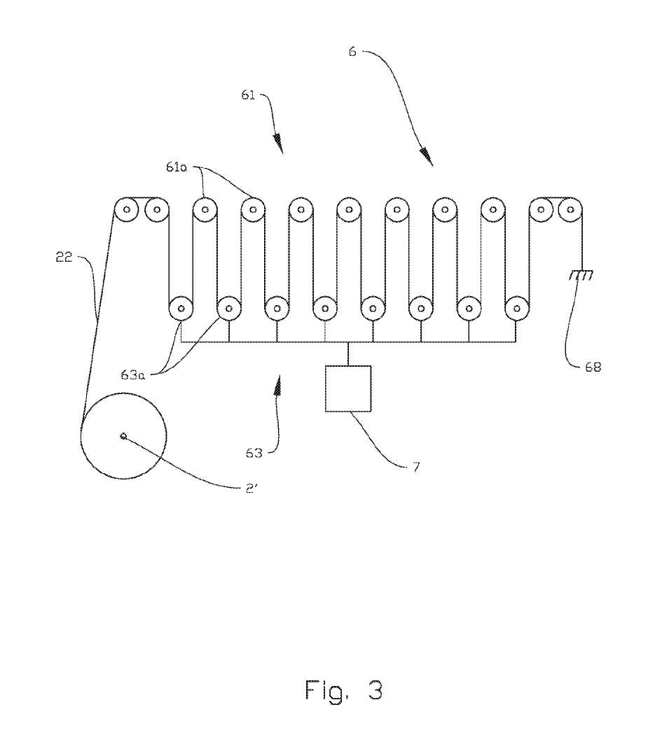

In FIG. 3, a prior art draw-works 6 with a 16:1 transmission is shown schematically and simplified. Upper sheaves 61a define a crown block 61, while lower sheaves 63a define a travelling block 63 connected to a load 7. This implies that for lowering or lifting a load 1 meter, the winch 2′ has to pay out or reel in 16 metres of wire rope 22, respectively. The wire rope 22 thus undergoes numerous bending cycles over relatively small sheaves 61a, 63a. The excessive ton/bending cycles imply a lifetime in the order of two weeks for such a system 6 used in active heave compensation on an offshore drilling rig. A traditional cut-and-slip operation thus has to be performed to replenish the wire rope 22 before the operation can continue. The distal end of the wire rope 22 is connected to a deadline anchor 68 as will be known to a person skilled in the art.

For comparison, FIG. 4 shows a simplified and schematic representation of a system 1 according to the present disclosure. The wire rope 21 only passes over one single sheave 51a in the crown block 51 and one single sheave 53a in the travelling block 53. The non-travelling end of the wire is connected to a deadline anchor 58, the system thus constituting a 2:1 transmission. Alternatively, the distal end of the wire rope 21 may also be connected to a deadline compensator 59 via a compensator sheave 57, the latter embodiment, shown in dashed lines in FIG. 4 and corresponding to the system 1 shown on FIG. 2. In the system 1 shown in FIG. 4, the wire rope 21 undergoes significantly fewer bending cycles than the wire rope 22 shown in FIG. 3 for several reasons:
sheaves 51a, 53a in the crown block 51 and travelling block 53 in system 1 are larger than the sheaves 61a, 63a in the conventional draw-works 6, implying that the wire rope 21 will travel a longer distance on each sheave/in contact with each sheave 51a, 53a before leaving the sheave 51a, 53a;
There are fewer sheaves 51a, 53a in the system 1 shown in FIG. 4 where the transmission may be in the range of 1:1 (direct line) to 4:1, in contrast to conventional draw-works 6. The wire rope 21 of system 1 thus “meets” fewer sheaves 51a, 53a;
The overall distance travelled by the wire rope 21 on the so-called fast line side of the system 1 is shorter due to the reduced transmission; and
The sheaves 51a, 53a may also be provided with a larger distance there between compared to the sheaves 61a, 63a of the prior art system 6.

In traditional draw-works 6 of FIG. 3, acceleration is hampered by a significant inertia loss in the plurality of fast-running small sheaves 61a, 63a. In a system 1 as disclosed in FIG. 4, however, acceleration will be more direct, hence increasing average hosting speed and thus reducing operation time. The winch 2 of the system 1 as shown in FIG. 4 is, as mentioned above, connected to a heave compensation means 8. The heave compensation means will typically include a not shown Motion Reference Unit, or the like, connected to a winch control unit as will be understood by a person skilled in the art. The heave compensation means 8 is therefore not discussed in further detail herein.

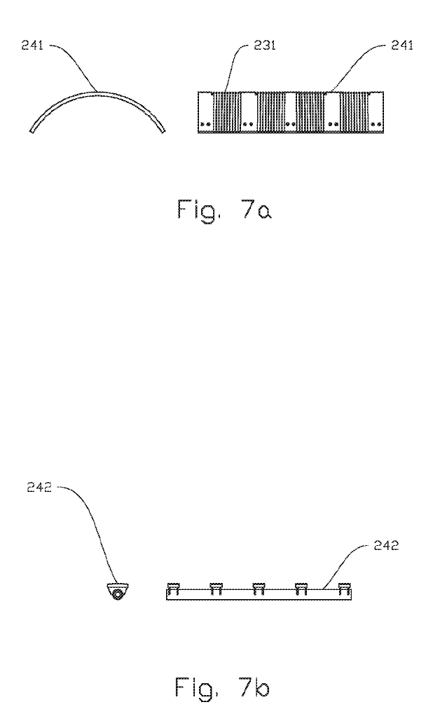

In FIG. 5, a second embodiment of a winch 2 is shown for use in a system 1 disclosed herein. The winch 2 is shown with most of its drive means 3, in the form of twenty four permanent magnet motors (PMMs) 3, twelve on each side of the winch 2, exposed for the overview. The winch 2 is shown without wire ropes 21, 21′, 21″, 21″′. The permanent magnet motors 3 are, in the shown embodiment, PMSMs (permanent magnet ac synchronous motors) of 350kW each. Each PMM 3 is connected to the winch drum 23 via a separate gear 31. The gear 31 is, in the shown embodiment, a two-step planetary gear with functionality as described in the general part of the description. Each gear 31 is connected to a gear shifting means 32 and to the winch drum 23 through a (not shown) gear ring-pinion connection. The gear 31 and gear shifting means 32 ensure that the PMMs 3 may be operated at an optimized, constant speed while the hoisting speed of the winch 2 itself may be varied between a fast mode and a slower/power mode, wherein in the slower mode the winch is configured to handle heavy loads 7, such as a whole drill string 7. Said driving means 3 would be the same on the winch 2 in FIG. 1. The winch 2 in FIG. 5 is shown in a first position of use A wherein the outer surface of the winch drum 23 is constituted by a removable shell 24, as will be discussed further below. Bolts 243 (best seen in FIG. 7) for connecting the removable shell 24 to support means 241 are also visible in FIG. 5. The person skilled in the art will also notice that various electric and hydraulic supply lines are not shown in the figures. The gear shifting means 32 may be hydraulically or electrically operated.

FIG. 6 shows the winch 2 from FIG. 5 in a second position of use B wherein the removable outer shell 24 has been removed. In this second position of use, the winch 2 is configured to accommodate multiple layers of wire rope 21 (not shown in the figure). The same winch 2 may thus be utilized both in derrick operations in active heave compensation (as in position of use A, for example), and as a subsea winch (as in position of use B, for example).

In FIG. 7a, one of three shell segments 241 constituting the removable shell 24 in FIG. 5 is shown, both in a side view (right) and in a front view (left) The shell segments 241 may be connected to the winch 2 via support means 242, shown in FIG. 7b as one of six crossbars connectable to a winch flange 244 (shown in FIG. 6), both in a side view (right) and in a front view (left). The crossbars 242 may be fitted into openings/recesses 245 (shown in FIG. 6) in the winch flange 244 and further bolted to the winch flange 244, and the shell segments 241 may be connected/bolted to the crossbars 242 to form a closed, removable shell 24.

1. System for hoisting a load on an offshore rig, the system comprising
a winch having a winch drum;
drive means for operating said winch;
one or more sheaves,
an elongated hoisting member, such as a wire rope, configured to run over said one or more sheaves and to connect said winch to the load, wherein said winch drum, in a first position of use (A), is configured to accommodate only a single layer of said elongated hoisting member.

2. System according to claim 1, wherein the system further comprises two or more parallel elongated hoisting members connecting said winches to said load.

3. System according to claim 1, wherein said winch drum is provided with a helical groove for accommodating said single layer of elongated hoisting member.

4. System according to claim 1, further comprising a heave compensation means.

5. System according to claim 1, wherein a ratio between the diameter of said winch drum in the first position of use (A) and the diameter of said elongated hoisting member is larger than 30.

6. System of claim 5 wherein a ratio between the diameter of said winch drum in the first position of use (A) and the diameter of said elongated hoisting member is larger than 40.

7. System of claim 5 wherein a ratio between the diameter of said winch drum in the first position of use and the diameter of said elongated hoisting member is larger than 60.

8. System according to claim 1, wherein said drive means is a plurality of electric drive means.

9. System according to claim 8, wherein said electric drive means are permanent magnet motors.

10. System according to claim 9, wherein each of said permanent magnet motor is connected to said winch via a separate gear.

11. System according to claim 10, wherein said separate gear is a two-step gear and wherein in a first gear, the winch is configured to lift and/or lower a first load, and wherein in a second gear, the winch is configured to perform multiple lifting and lowering operations of a second load.

12. System according to claim 11, wherein each of said separate gears is connected to a separate gear shifting means configured to switch gears and to disconnect from said winch the permanent magnet motor, to which the gear is connected.

13. System according to claim 1 wherein said elongated hoisting member is a galvanized steel wire.

14. System according to claim 1 wherein said elongated hoisting member is a wire rope including more than six strands.

15. System according to claim 1 wherein said winch comprises a removable shell defining an outer layer of said winch drum, and wherein the winch with said removable shell in place defines said first position of use (A), and wherein said winch without said removable shell in place defines a second position of use (B) wherein the winch drum has a smaller diameter than when in said first position of use (A) configured.

16. System according to claim 15, wherein said removable shell includes a plurality of shell segments configured to be assembled together so as to define said removable shell.

17. System for hoisting a load on an offshore rig, the system comprising:
a winch having a winch drum that is reconfigurable to have at least two operating configurations;
a plurality of electric drive motors configured to rotate said winch drum;
a plurality of sheaves;
a wire rope connected to the load and configured to run over said plurality of sheaves and be disposed about said winch drum;
wherein said winch drum comprises a first surface having a first diameter configured to receive thereon multiple layers of said wire rope, and further comprising a removable shell defining a second surface having a second diameter that is larger than said first diameter and configured to receive one layer of said wire rope.

18. The system of claim 17 wherein said second surface comprises a helical groove formed therein, and wherein said wire rope is disposed in said groove.

19. The system of claim 16 wherein said second surface comprises a plurality of shell segments connected together with fasteners to form said shell, said shell covering said first surface of said winch drum.

20. The system of claim 16 wherein the ratio between the diameter of said second surface and the diameter of said wire rope is larger than 30.

21. The system of claim 20 wherein said wire rope comprises at least six strands of galvanized steel.
